(19) United States
(12) Patent Application Publication
(10) Pub. No.: US 2026/0288377 A1
(43) Pub. Date: Sep. 24, 2026

(54) DYNAMIC ERASE SUSPENSION BASED ON QUEUE DEPTH

(71) Applicant: Micron Technology, Inc., Boise, ID (US)

(72) Inventors: Jiangang Wu, Milpitas, CA (US); Chandra Mouli Guda, Fremont, CA (US); Shakeel Bukhari, San Jose, CA (US); Dheeraj Dake, San Jose, CA (US)

(21) Appl. No.: 19/086,963

(22) Filed: Mar. 21, 2025

(51) Int. Cl. G06F 3/06

(52) U.S. Cl. CPC G06F 3/0659; G06F 3/0604; G06F 3/0679

(57) ABSTRACT

This disclosure is directed to a system for dynamically suspending erase operations on a memory device. The system determines a queue depth of pending host read commands while an erase operation is in progress on a memory device. The system determines whether the queue depth transgresses a threshold value. The system, in response to determining whether the queue depth transgresses the threshold value, selects an erase suspend operation from a plurality of erase suspend operation types and suspends the erase operation on the memory device using the selected erase suspend operation.

### TECHNICAL FIELD

Examples of the disclosure relate generally to memory sub-systems and, more specifically, to performing dynamic erase suspend operations in NAND flash memory devices.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various examples of the disclosure. The drawings, however, should not be taken to limit the disclosure to the specific examples, but are for explanation and understanding only.

FIG. 1 is a block diagram illustrating an example computing system that includes a memory sub-system, in accordance with some examples.

FIG. 2 illustrates a plurality of erase segments including suspend points, in accordance with some examples.

FIG. 3 illustrates a flow diagram of erase suspend operations, in accordance with some examples.

FIG. 4 illustrates a flow diagram of erase suspend operations, in accordance with some examples.

FIG. 5 is a block diagram of an example computer system, according to some examples.

### DETAILED DESCRIPTION

The present disclosure is directed to a system including a memory device and a processing device operatively coupled to the memory device. The processing device is programmed to perform operations that improve read Quality of Service (QoS) through an innovative dynamic erase suspend feature. The system achieves this by implementing queue depth (QD) awareness to selectively apply different types of erase suspend operations based on the number of pending host read commands. Specifically, the disclosed processing device tracks a host read QD, determines a current erase operation segment, and manages multiple suspend modes including auto-fixed, fast on-demand, and slow on-demand suspends based on the QD and current erase operation segment. This approach enhances read performance by reducing read latency for low QD (e.g., a QD that has less host read commands than a threshold) operations while maintaining system stability through controlled suspend limits. This can improve overall memory sub-system performance and efficiency by enabling dynamic servicing of host read commands during erase operations through intelligent suspend point selection and timing.

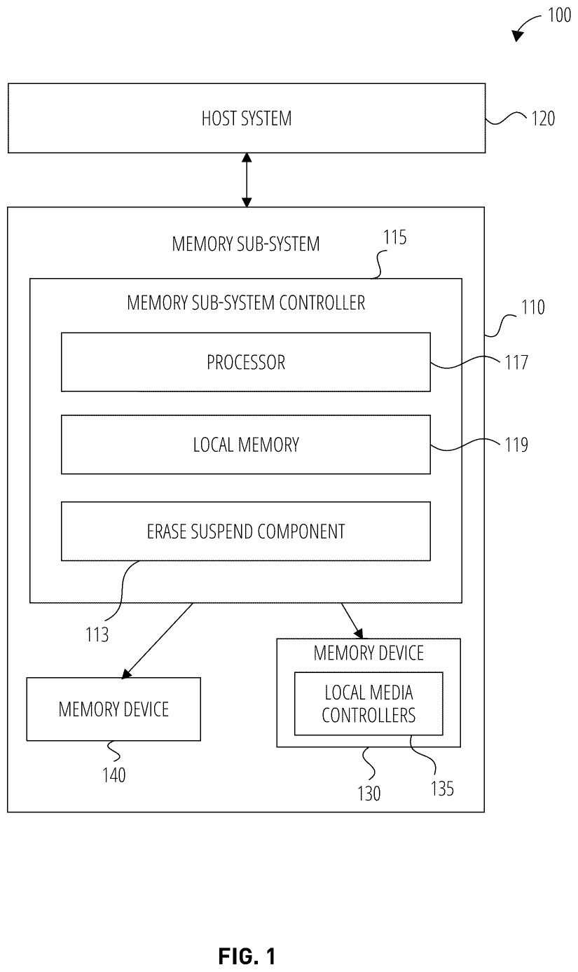

A memory sub-system can be a storage device, a memory module, or a hybrid of a storage device and memory module. Examples of storage devices and memory modules are described below in conjunction with FIG. 1. In general, a host system can utilize a memory sub-system that includes one or more components, such as memory devices that store data. The host system can send access requests to the memory sub-system, such as to store data at the memory sub-system and to read data from the memory sub-system.

The host system can send access requests (e.g., write command, read command, erase command) to the memory sub-system, such as to store data on a memory device at the memory sub-system, read data from the memory device on the memory sub-system, or write/read constructs (e.g., such as submission and completion queues) with respect to a memory device on the memory sub-system. The data to be read or written, as specified by a host request, is hereinafter referred to as “host data” or “user data.”

A host request can include logical address information (e.g., logical block address (LBA), namespace) for the host data, which is the location the host system associates with the host data and a particular zone in which to store or access the host data. The logical address information (e.g., LBA, namespace) can be part of metadata for the host data. Metadata can also include error handling data (e.g., error-correcting code (ECC) code word, parity code), data version (e.g., used to distinguish age of data written), valid bitmap (which LBAs or logical transfer units contain valid data), and so forth.

The memory sub-system can initiate media management operations, such as a write operation, on host data that is stored on a memory device. For example, firmware of the memory sub-system may re-write previously written host data from a location of a memory device to a new location as part of garbage collection (GC) management operations. The data that is re-written, for example as initiated by the firmware, is hereinafter referred to as “GC data.” Examples of system data include, but are not limited to, system tables (e.g., logical-to-physical memory address mapping table, also referred to herein as a logical-to-physical (L2P) mapping table (referred to as an L2P table), data from logging, scratch pad data, and so forth).

A memory device can be a non-volatile memory device. A non-volatile memory device is a package of one or more die. Each die can be comprised of one or more planes. For some types of non-volatile memory devices (e.g., AND-type devices), each plane is comprised of a set of physical blocks. For some memory devices, blocks are the smallest area that can be erased. Each block is comprised of a set of pages. Each page is comprised of a set of memory cells, which store bits of data. The memory devices can be raw memory devices (e.g., NAND), which are managed externally, for example, by an external controller. The memory devices can be managed memory devices (e.g., managed NAND), which are raw memory devices combined with a local embedded controller for memory management within the same memory device package. The memory device can be divided into one or more zones where each zone is associated with a different set of host data or user data or application.

Certain memory devices, such as NAND-type memory devices, include one or more blocks, (e.g., multiple blocks), with each of those blocks including multiple memory cells. For instance, a memory device can include multiple pages (stored across one or more word lines (WLs)), with each page including a subset of memory cells of the memory device. A threshold voltage (VT) of a memory cell (of a block) can be the voltage at which the floating gate (e.g., NAND transistor), implementing the memory cell, turns on and conducts (e.g., to a bit line coupled to the memory cell). Generally, writing data to such memory devices involves programming (by way of a program operation) the memory devices at the page level of a block, and erasing data from such memory devices involves erasing the memory devices at the block level (e.g., page level erasure of data is not possible).

In NAND flash memory devices, erase operations are fundamental but time-consuming processes that can impact read performance and QoS. An erase operation usually is performed across multiple segments including a partial block erase (PBE) segment (e.g., with operations that take about 500 microseconds to complete), an erase pulse segment (e.g., with operations that take about 1800 microseconds to complete), a verification segment (e.g., that can take hundreds of microseconds to complete, and an select-gate (SG) check segment (e.g., taking 12 microseconds to complete). These lengthy operations can block host read commands, leading to poor QoS, such as during mixed workloads.

Some conventional systems employ erase suspend operations. Erase suspend operations allow a NAND flash memory device to temporarily pause an ongoing erase operation (in one of the multiple segments) to service higher priority host read commands. From a host perspective, reads and read QoS are the highest priority, so being able to predictably interrupt erase commands is important. Conventional erase suspend approaches rely on predetermined auto-fixed suspend points where the NAND device automatically pauses the erase operation once a given segment is completed. The NAND device usually resumes the erase operation with the next segment when a command is issued to continue by the controller. While this approach ensures predictable forward progress, this approach forces the system to wait for these fixed points even when immediate host reads are pending.

In an effort to address this issue, certain conventional systems make two types of on-demand suspend operations are available during the erase pulse segment, which is the longest segment at 1800 microseconds. These on-demand suspend operations allow the controller to suspend the erase operation before reaching the fixed points at which the erase operation is automatically suspended. A slow on-demand suspend may require waiting 800 microseconds before issuing the suspend command to ensure forward progress is made in the erase operation (e.g., in the erase pulse segment). The slow on-demand suspend operation can ensure that erase operations do not need to be repeated when the erase operation is ultimately resumed by the controller. A fast on-demand suspend allows immediate suspension with minimal delay (e.g., 85 microseconds) but may require repeating some operations of the erase pulse when resumed since forward progress is not guaranteed. These on-demand suspends are limited to just the erase pulse segment, while other segments like PBE (500 microseconds) and verify operations (400 microseconds) can only be suspended at predetermined auto-fixed points. This restrictive approach leads to poor read latency, particularly for low QD operations that may require quick servicing of host reads.

Current systems lack QD awareness, leading to unnecessary suspends that quickly exhaust the limited number of allowed suspend operations. These systems lack intelligent suspend timing management. The systems usually either wait for predetermined auto-fixed suspend points, which can add unnecessary latency of up to 1800 microseconds during the erase pulse segment, or use basic on-demand suspends that rely on conservative worst-case timing to ensure forward progress. This results in either excessive latency waiting for suspend points or wasted operations from repeated erase pulses when forward progress is not guaranteed.

The present disclosure addresses these inefficiencies by implementing a dynamic erase suspend system that combines QD awareness with intelligent suspend timing management. The disclosed techniques monitor host read QD to selectively apply different types of suspend operations. Namely, the disclosed techniques can use fast on-demand suspends with zero (or minimal) minimum wait time across all or certain set of erase segments (e.g., all erase segments excluding the SG check segment) for low QDs (e.g., less than four pending commands to service)), while restricting on-demand suspend operations to only the erase pulse segment with longer wait times for higher QDs (e.g., a QD that has more host read commands than the threshold). The disclosed system leverages memory device commands to track the current erase segment and remaining time in the erase segment to avoid unnecessary suspends when segments are close to completion (e.g., less than amount of time it takes to service an on-demand erase suspend operation, such as 85 microseconds). This intelligent timing management prevents wasted suspend operations while still maintaining sufficient read latency. Additionally, the system carefully manages suspend operation limits by tracking both fast on-demand suspends and total suspends to ensure system stability. This comprehensive approach results in improved read latency while maintaining predictable performance across different workload scenarios, which improves QoS and the overall efficiency of the memory sub-system.

In some examples, a memory sub-system is provided for managing erase operations in a memory device. The memory sub-system includes a processing device that monitors the QD of pending host read commands during an erase operation. The processing device determines whether the QD transgresses a threshold value and selectively applies different types of erase suspend operations based on this determination.

The processing device supports multiple types of erase suspend operations, including auto-fixed suspend operations that are automatically initiated by the memory device at predetermined points, fast on-demand suspend operations that can suspend immediately with minimal delay, and slow on-demand suspend operations that ensure forward progress. The auto-fixed suspend points occur at segment boundaries, while on-demand suspends can be triggered by the system based on QD and timing conditions.

In some cases, when suspending an erase operation, the processing device considers the current erase segment type and remaining time in the current erase segment. The erase operation includes multiple segments including PBE, erase pulse, and verify segments. The fast on-demand suspend operations can interrupt any of these segments immediately but may require repeating operations upon resuming the erase operation, particularly during the erase pulse segment. Slow on-demand suspends are restricted to the erase pulse segment and include a minimum wait time to ensure forward progress.

The processing device tracks both the number of fast on-demand suspends and total suspend operations to prevent exceeding defined limits. The processing device can specify commands to determine the current erase segment and remaining time, enabling the processing device to intelligently perform suspend decisions. For segments with very short remaining times (e.g., less time than the amount of time it takes to service a suspend operation), the processing device may select auto-fixed suspend instead of on-demand suspend to optimize performance.

The processing device manages suspend operations differently based on QD. This enables aggressive fast suspends across all segments for low QDs while restricting to slow suspends during erase pulse segments for higher QDs. This approach balances the need for low latency read performance against system stability and resource constraints.

Though various examples are described herein as being implemented with respect to a memory sub-system (e.g., a controller of the memory sub-system), some or all of the portions of an example can be implemented with respect to a host system, such as a software application or an operating system of the host system.

FIG. 1 illustrates an example computing system 100 that includes a memory sub-system 110, in accordance with some examples. The memory sub-system 110 can include media, such as one or more volatile memory devices (e.g., memory device 140), one or more non-volatile memory devices (e.g., memory device 130), or a combination of such. Any discussion with respect to memory device 130 is similarly applicable to memory device 140 and vice versa.

A memory sub-system 110 can be a storage device, a memory module, or a hybrid of a storage device and memory module. Examples of a storage device include a solid-state drive (SSD), a flash drive, a universal serial bus (USB) flash drive, a secure digital (SD) card, an embedded Multi-Media Controller (eMMC) drive, a Universal Flash Storage (UFS) drive, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some examples, the host system 120 is coupled to different types of memory sub-systems 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., NVDIMM controller), and a storage protocol controller (e.g., a peripheral component interconnect express (PCIe) controller, serial advanced technology attachment (SATA) controller). The host system 120 uses the memory sub-system 110, for example, to write data to the memory sub-system 110 and read data from the memory sub-system 110.

The host system 120 can include or be coupled to the memory sub-system 110 so that the host system 120 can read data from or write data to the memory sub-system 110. The host system 120 can be coupled to the memory sub-system 110 via a physical host interface. Examples of a physical host interface include, but are not limited to, a serial advanced technology attachment (SATA) interface, a peripheral component interconnect express (PCIe) interface, a compute express link (CXL) interface, a universal serial bus (USB) interface, a Fibre Channel interface, a Serial Attached SCSI (SAS) interface, etc. The physical host interface can be used to transmit data between the host system 120 and the memory sub-system 110. The host system 120 can further utilize an NVM Express (NVMe) interface to access the memory devices 130, 140 when the memory sub-system 110 is coupled with the host system 120 by the PCIe or CXL interface. The physical host interface can provide an interface for passing control, address, data, and other signals between the memory sub-system 110 and the host system 120.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a NAND type flash memory and write-in-place memory, such as a 3D cross-point memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional (2D) NAND and 3D NAND.

Each of the memory devices 130, 140 can include one or more arrays of memory cells. One type of memory cell, for example, single level cells (SLCs), can store one bit per cell. Other types of memory cells, such as multi-level cells (MLCs), tri-level cells (TLCs), quad-level cells (QLCs), and penta-level cells (PLCs), can store multiple bits per cell. In some examples, each of the memory devices 130, 140 can include one or more arrays of memory cells such as SLCs, MLCs, TLCs, QLCs, or any combination of such. In some examples, a particular memory device can include an SLC portion, and an MLC portion, a TLC portion, or a QLC portion of memory cells. The memory cells of the memory devices 130, 140 can be grouped as pages that can refer to a logical unit of the memory device used to store data. With some types of memory (e.g., NAND), pages can be grouped to form blocks or BSs. As used herein, a block including SLCs can be referred to as a SLC block, a block including MLCs can be referred to as an MLC block, a block including TLCs can be referred to as a TLC block, and a block including QLCs can be referred to as a QLC block.

Although non-volatile memory components such as NAND type flash memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, and electrically erasable programmable read-only memory (EEPROM).

A memory sub-system controller 115 (or controller 115 for simplicity) can communicate with the memory devices 130, 140 to perform operations such as reading data, writing data, or erasing data (e.g., performing GC operations) at the memory devices 130, 140 and other such operations. The memory sub-system controller 115 can include hardware such as one or more integrated circuits and/or discrete components, a buffer memory, or a combination thereof. The hardware can include digital circuitry with dedicated (e.g., hard-coded) logic to perform the operations described herein. The memory sub-system controller 115 can be a microcontroller, special purpose logic circuitry (e.g., a field programmable gate array (FPGA), an application specific integrated circuit (ASIC), and so forth), or other suitable processor. The memory sub-system controller 115 can perform erase operations and erase suspend operations on the memory device 130. For example, the erase operation can be performed in multiple or a plurality of segments (e.g., a PBE segment, an erase pulse segment, an erase verify segment, and/or an SG check segment). The erase suspend operations can include auto-fixed suspend operation, slow on-demand suspend operations, and/or fast on-demand suspend operations.

The auto-fixed suspend operation is automatically initiated by the memory device at predetermined suspend points between the erase segments. When an auto-fixed suspend point is reached, the NAND device automatically pauses the erase operation and allows the memory sub-system controller 115 to service pending host read commands before resuming the erase operation with the next segment. This ensures predictable forward progress but requires waiting for fixed suspend points. The slow on-demand suspend operation can be initiated by the memory sub-system controller 115 during the erase pulse segment (e.g., after waiting 800 microseconds to ensure forward progress). This minimum wait time allows the erase operation to make sufficient progress before suspending, preventing the need to repeat erase pulse operations when resumed. The slow on-demand suspend can be restricted to the erase pulse segment and can be used for higher QD scenarios. The fast on-demand suspend operation allows immediate suspension with minimal delay (e.g., 85 microseconds) and can be performed during any erase segment when the QD is low. While this provides the fastest response to service pending host reads, suspending during certain segments like the erase pulse may require repeating some operations when the erase operation is resumed since forward progress is not guaranteed. In some cases, the memory sub-system controller 115 limits the number of fast on-demand erase suspend operations (or fast on-demand suspend requests or commands) to a maximum threshold (e.g., 25) per erase operation to maintain stability.

The memory sub-system controller 115 can carefully manage these suspend operations based on QD, remaining segment time, and suspend operation counts to optimize read latency while maintaining system stability. For segments with very short remaining times (less than 85 microseconds), the memory sub-system controller 115 may select auto-fixed suspend instead of on-demand suspend to prevent unnecessary overhead.

The memory sub-system controller 115 can include a processor (processing device 117) configured to execute instructions stored in local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some examples, the local memory 119 can include memory registers storing memory pointers, fetched data, and so forth. The local memory 119 can also include ROM for storing micro-code. While the example memory sub-system 110 in FIG. 1 has been illustrated as including the memory sub-system controller 115, in another example, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, GC operations, error detection and ECC operations, encryption operations, caching operations, and address translations between a logical address (e.g., LBA, namespace) and a physical memory address (e.g., physical block address in a physical address space of the memory device 130 or memory device 140) that are associated with the memory devices 130, 140. The memory sub-system controller 115 can further include host interface circuitry to communicate with the host system 120 via the physical host interface. The host interface circuitry can convert the commands received from the host system 120 into command instructions to access the memory device 130 and/or the memory device 140 as well as convert responses associated with the memory device 130 and/or the memory device 140 into information for the host system 120.

The memory sub-system 110 can also include additional circuitry or components that are not illustrated. In some examples, the memory sub-system 110 can include a cache or buffer (e.g., DRAM) and address circuitry (e.g., a row decoder and a column decoder) that can receive an address from the memory sub-system controller 115 and decode the address to access the memory devices 130, 140.

The memory sub-system 110 can include a queue that stores pending host read commands. The queue tracks the number of outstanding read requests waiting to be serviced. The QD (QD) represents how many read commands are pending at any given time. For example, a QD of 1 means there is a single pending read command, while a QD of 4 means there are 4 read commands waiting to be processed. The memory sub-system controller 115 monitors this QD to make intelligent decisions about erase suspend operations. When the QD is low (e.g., 4 or fewer pending commands), the memory sub-system controller 115 allows aggressive fast on-demand suspend operations across all (or certain set of) erase segments to minimize read latency. When the QD is high (e.g., more than 4 pending commands), the memory sub-system controller 115 can restrict suspend operations to only occur during the erase pulse segment to prevent exhausting the limited number of allowed suspends.

The queue can be managed by channel processors that serve as intermediaries between the memory sub-system controller 115 and the memory devices 130. These channel processors receive read commands from the host, track the QD, and coordinate with the erase suspend component 113 to determine when to suspend ongoing erase operations to service the queued read requests. This QD awareness enables the memory sub-system 110 to optimize read performance while maintaining system stability through controlled suspend operations.

In some examples, the memory device 130 includes local media controllers 135 that operate in conjunction with memory sub-system controller 115 to execute operations on one or more memory cells of the memory device 130. An external controller (e.g., memory sub-system controller 115) can externally manage the memory device 130 (e.g., perform media management operations on the memory device 130). In some examples, a memory device 130 is a managed memory device, which is a raw memory device combined with a local controller (e.g., local media controller 135) for media management within the same memory device package. An example of a managed memory device is a managed NAND (mNAND) device. Any operation discussed as being performed by the memory sub-system controller 115 can be similarly performed by the local media controllers 135 and vice versa.

The memory sub-system 110 can include an erase suspend component 113 that manages erase suspend operations based on QD awareness and intelligent timing. The erase suspend component 113 can monitor the QD of pending host read commands during ongoing erase operations to determine whether to perform fast or slow on-demand suspend operations and/or whether to wait for auto-fixed suspend operations to be performed.

In some cases, for low QDs (e.g., four or fewer pending commands), the erase suspend component 113 enables fast on-demand suspend operations with zero minimum wait time across erase segments including PBE, erase pulse, and verify segments. For high QDs (e.g., more than four pending commands), the erase suspend component 113 can restrict suspend operations to only occur during the erase pulse segment using slow on-demand suspends with an 800 microsecond minimum wait time and/or fast on-demand suspend operations.

The erase suspend component 113 can use certain trim commands to track the current erase segment of the memory device 130 and remaining time in that erase segment. This allows the erase suspend component 113 to avoid unnecessary suspends when segments are close to completion (e.g., less than 85 microseconds remaining).

In some examples, the erase suspend component 113 maintains separate counters for fast on-demand suspends (e.g., with a maximum threshold of 25) and total suspend operations (e.g., with a maximum of 30) to prevent exceeding system limits. For each suspend decision, the erase suspend component 113 evaluates the QD, current erase segment, remaining segment time, and suspend operation counts to select the optimal erase suspend type.

For example, during the PBE segment, the erase suspend component 113 continuously or periodically monitors the QD of pending host read commands. When operating in low QD conditions (e.g., QD≤4), the erase suspend component 113 communicates with memory device 130 via certain trim commands to determine the current segment progress. Namely, the erase suspend component 113 can transmit an erase progress command to the memory device 130. The memory device 130 can respond to the command with the current erase segment and amount of time elapsed in that segment and/or amount of time remaining to complete operations of the segment. In some cases, if the PBE segment has 300 microseconds remaining and both the current number of fast suspend operations and total number of suspend operations performed by the memory device 130 are below their respective maximum thresholds of, for example 25 and 30, the erase suspend component 113 selects and issues a fast on-demand suspend command or operation to the memory device 130. The current number of fast suspend operations is incremented when a new fast suspend operation is issued or performed and is decremented when an individual fast suspend operation is resumed. The total number of suspend operations is incremented when a new fast suspend operation and/or a slow suspend operation is issued or performed and is decremented when any individual on-demand suspend operation (e.g., fast or slow on-demand suspend operation) is resumed.

In contrast, when operating with a higher QD (QD>4) or when the PBE segment has less than 85 microseconds remaining, the erase suspend component 113 defaults to auto-fixed suspend points. The erase suspend component 113 makes this determination after confirming via the specified trim command that insufficient time remains to make an on-demand suspend worthwhile.

In some examples, for the erase pulse segment, which is the longest at 1800 microseconds, the erase suspend component 113 applies similar logic but with different timing thresholds. During low QD operations, if 1000 microseconds remain and suspend counts permit (fast count<25, total<30), the erase suspend component 113 issues a fast on-demand suspend operation/request. Such a command may necessitate repeating some operations of the erase pulse segment when resumed by the erase suspend component 113. For high QDs, the erase suspend component 113 can switch to slow on-demand suspend operations or requests with an 800 microsecond wait time, provided the total suspend count has not reached the maximum threshold, such as 30.

During verify segments, the erase suspend component 113 allows fast on-demand suspends only during low QD scenarios when 200 microseconds or more remain and suspend counts allow. For high QDs, the erase suspend component 113 restricts operation to auto-fixed erase suspend points only. For the brief SG check segment (12 microseconds), the erase suspend component 113 may never allow on-demand suspend operations since the operations to complete the SG segment take less time than the minimum suspend operation time of, for example 85 microseconds.

Throughout all segments, the erase suspend component 113 maintains constant communication with memory device 130 through trim commands to track segment progress and make optimal suspend decisions. This enables dynamic selection between suspend types while carefully managing both fast suspend (max 25) and total suspend (max 30) operation counts to maintain system stability. For very short segments, like SG check (12 microseconds), the erase suspend component 113 can prevent on-demand suspend operations since the overhead for completing the on-demand erase suspend request/operation may exceed the remaining time to complete all the operations in that segment.

The erase suspend component 113 can enable auto-fixed suspend operations at predetermined points between segments when on-demand suspends are not optimal due to timing or system constraints. When resuming suspended erase operations, the erase suspend component 113 manages the potential need to repeat portions of interrupted segments, particularly during fast on-demand suspends of the erase pulse segment.

For segments near completion, the erase suspend component 113 may select auto-fixed suspend instead of on-demand suspend to optimize performance. The erase suspend component 113 prevents unnecessary suspends during high QD scenarios to maintain system stability and avoid exhausting suspend operation limits. Through QD awareness and intelligent timing management, the erase suspend component 113 balances the need for low latency reads against system stability and resource constraints.

The erase suspend component 113 can be implemented in hardware, software, firmware or combinations thereof within the memory sub-system controller 115. The erase suspend component 113 receives commands from the memory sub-system controller 115 and translates them into specific suspend operations for the memory devices. The erase suspend component 113 reports completion status back to the memory sub-system controller 115 after executing suspend operations. The erase suspend component 113 maintains this comprehensive suspend management approach across multiple memory devices and channels to optimize overall system performance.

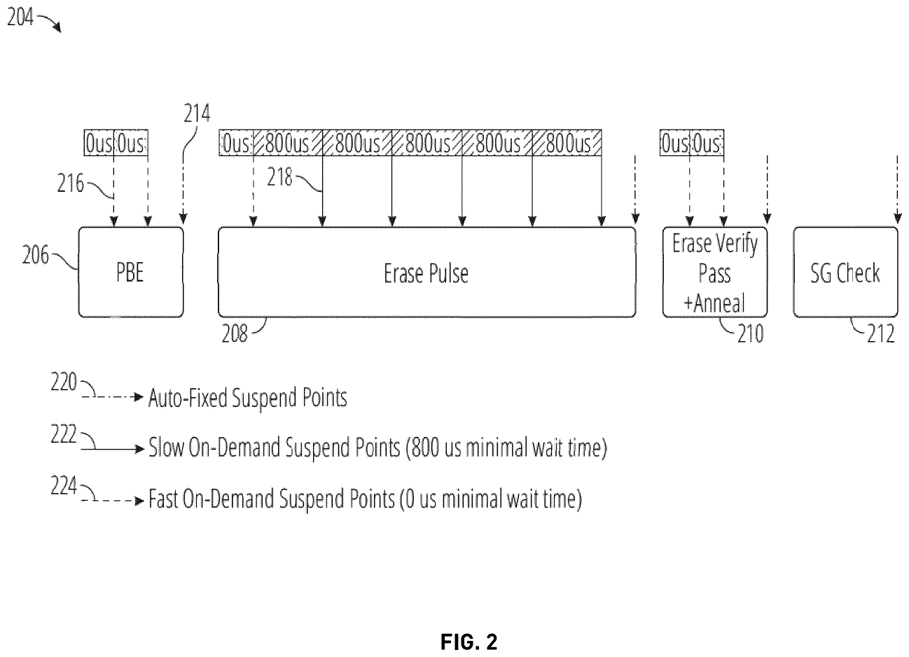

FIG. 2 illustrates a plurality of erase segments 204 including suspend points, in accordance with some examples. Specifically, FIG. 2 shows erase segments 204 arranged sequentially including a PBE segment 206, an erase pulse segment 208, an erase verify segment 210, and an SG check segment 212. A legend at the bottom of FIG. 2 identifies the three types of suspend points that are shown in relation to the erase segments 204 as when they can be performed. The legend identifies auto-fixed suspend operation points 220, slow on-demand suspend operation points 222, and fast on-demand suspend operation points 224.

The PBE segment 206 represents the partial block erase phase lasting about 500 microseconds. During this PBE segment 206, the erase suspend component 113 can initiate either an auto-fixed suspend operations 214 or a fast on-demand suspend operation 216 when the QD is low, and the outstanding number of fast on-demand suspend operations is less than a maximum threshold.

The erase pulse segment 208 is the longest erase segment at about 1800 microseconds. This erase pulse segment 208 shows multiple suspend options including an auto-fixed suspend operation, slow on-demand suspend operation 218, and fast on-demand suspend operation. The fast on-demand suspend operation can occur at any time during the PBE segment 206, erase verify segment 210, and/or erase pulse segment 208 when QD is low. This allows immediate suspension with minimal delay. The auto-fixed suspend operation 214 are predetermined points where the memory device 130 automatically pauses the erase operation before moving on to the next erase segment.

The erase verify segment 210 includes verification operations and an anneal period, taking approximately 400 microseconds. Like the PBE segment 206, the erase verify segment 210 supports both auto-fixed and fast on-demand suspend points when QD is low. The SG check segment 212 is the shortest at about 12 microseconds. Due to its brief duration, this SG check segment 212 may only supports auto-fixed suspend operation since on-demand suspends would take longer than the segment itself.

The erase suspend component 113 uses this segmented structure to intelligently select suspend points based on QD, remaining segment time, and suspend operation counts. For low QDs, the erase suspend component 113 enables fast suspends across all segments except SG check. For high QDs, the erase suspend component 113 restricts operation to slow on-demand suspends during the erase pulse segment 208 only, using the 800 microsecond spaced points to ensure forward progress.

The spacing of suspend points illustrates how the erase suspend component 113 balances the need for quick response to host reads against maintaining predictable forward progress in the erase operation. FIG. 2 demonstrates how different suspend types are applied across segments, such as from aggressive fast suspends for low QDs to more conservative slow suspends for high QDs.

This segmented approach with multiple suspend options enables the erase suspend component 113 to optimize read latency while maintaining system stability through controlled suspend operations.

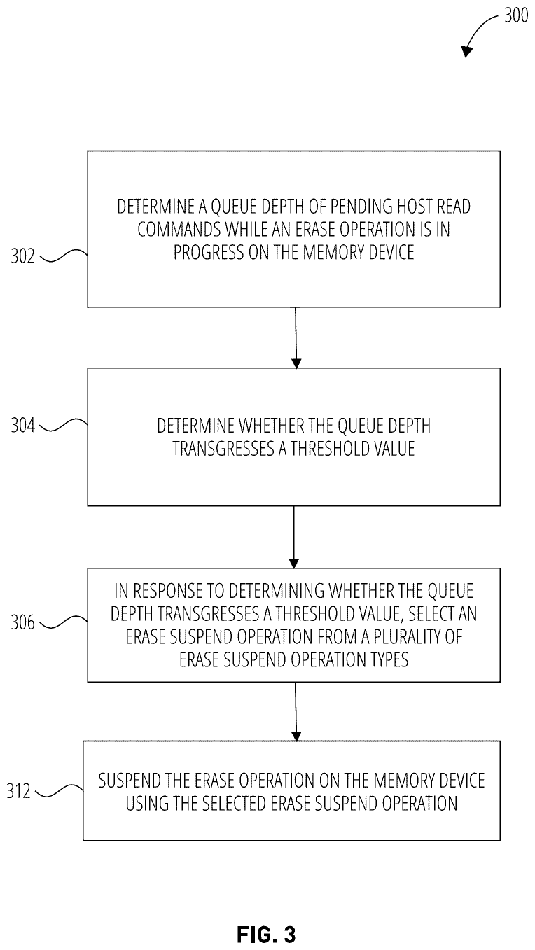

FIG. 3 illustrates a flow diagram 300 of erase suspend operations, in accordance with some examples. The process can be implemented through various forms of processing logic, including hardware components (such as processing devices, dedicated logic circuits, programmable logic, microcode, or integrated circuits), software instructions executed on a processing device, or combinations thereof. The memory sub-system controller 115 or its subcomponents can perform these operations, with the erase suspend component 113 handling key aspects of the process.

The flow diagram 300 begins at operation 302, where the erase suspend component 113 determines a QD of pending host read commands while an erase operation is in progress on the memory device 130. This involves monitoring how many read commands are waiting to be serviced.

At operation 304, the erase suspend component 113 determines whether the QD transgresses a threshold value, such as determining if the QD is above or below a value of 4 pending commands. At operation 306, in response to determining whether the QD transgresses the threshold value, the erase suspend component 113 selects an erase suspend operation from multiple types including auto-fixed erase suspend, fast on-demand erase suspend, or slow on-demand erase suspend operations. The selection is based on the QD determination and other factors like the current erase segment and remaining time.

For example, during the PBE segment with 300 microseconds remaining and a QD of 2 (e.g., below the threshold), the erase suspend component 113 first verifies that the current fast suspend count of, for example 20, is below the maximum threshold of 25 and the total suspend count of, for example 25, is below the limit of 30. After confirming these conditions are met, the erase suspend component 113 selects a fast on-demand suspend operation with zero minimum wait time to minimize read latency. However, if the fast suspend count has reached 25, the erase suspend component 113 can select a slow on-demand suspend operation instead, even though the QD is low, to avoid exceeding the maximum allowed fast on-demand erase suspends. After confirming the appropriate suspend type based on these counts, the erase suspend component 113 proceeds with the selected suspend operation to minimize read latency while maintaining system stability.

In contrast, during the erase pulse segment with 1200 microseconds remaining and a QD of 8 (e.g., above threshold), the erase suspend component 113 checks that the total suspend count of 28 is still below the maximum of 30. Since the QD exceeds the threshold, the erase suspend component 113 selects a slow on-demand suspend operation which can include an 800 microsecond wait time to ensure forward progress is maintained.

For segments nearing completion, such as a verify segment with only 50 microseconds remaining, the erase suspend component 113 selects an auto-fixed suspend operation regardless of QD. This is because the remaining time is less than the minimum 85 microseconds required for an on-demand suspend operation. The selection process carefully weighs multiple factors including the QD threshold of 4, current segment type determined via trim commands, remaining segment time, fast suspend count limit of 25, and total suspend count limit of 30. This comprehensive approach enables optimal suspend selection while preventing exhaustion of suspend operations and maintaining system stability.

Then, at operation 312, the erase suspend component 113 suspends the erase operation on the memory device 130 using the selected erase suspend operation type. This allows pending host read commands to be serviced before resuming the erase operation.

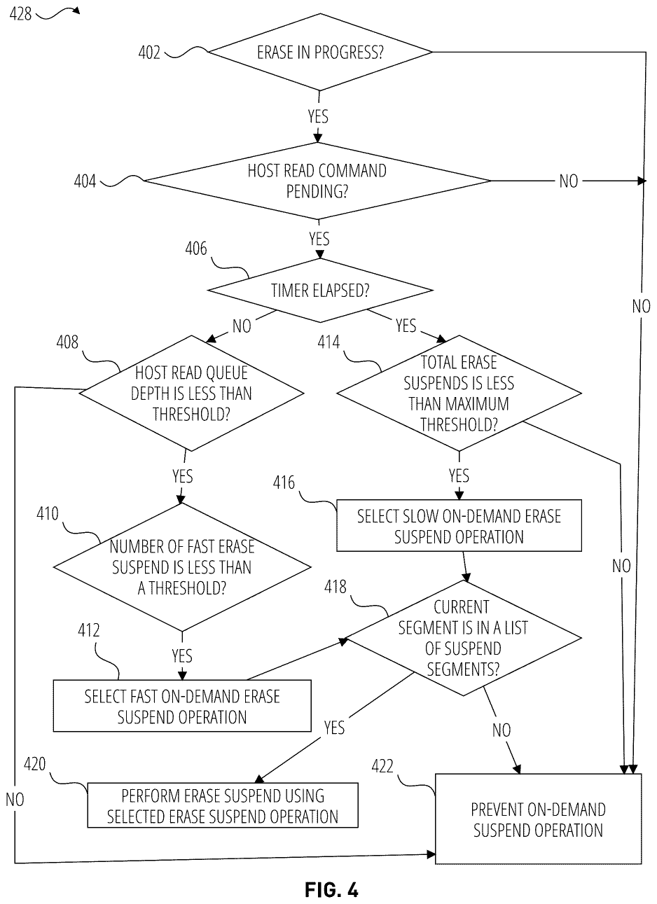

FIG. 4 illustrates a detailed flow diagram 428 of erase suspend operations, in accordance with some examples. The process can be implemented through various forms of processing logic, including hardware components (such as processing devices, dedicated logic circuits, programmable logic, microcode, or integrated circuits), software instructions executed on a processing device, or combinations thereof. The memory sub-system controller 115 or its subcomponents can perform these operations, with the erase suspend component 113 handling key aspects of the process.

The flow diagram 428 begins at operation 402, where the erase suspend component 113 determines if an erase operation is in progress on the memory device 130. If the erase suspend component 113 determines that erase is currently in progress on the memory device 130, the erase suspend component 113 proceeds to operation 404, where the erase suspend component 113 checks for pending host read commands. If a host read command is pending, the erase suspend component 113 continues to operation 406 to check if a timer has elapsed.

If the timer has not elapsed, the erase suspend component 113 proceeds to operation 408 where the erase suspend component 113 determines if the host read QD is less than a threshold value (e.g., 4). For low QDs, at operation 410, the erase suspend component 113 checks if the number of fast erase suspends performed is below a maximum threshold (e.g., 25). If both conditions are met (e.g., QD is less than a threshold and the number of fast erase suspends performed is below the maximum threshold), the erase suspend component 113 selects a fast on-demand erase suspend operation at operation 412. After performing operation 412, the erase suspend component 113 proceeds to operation 418.

If the timer has elapsed at operation 406, the erase suspend component 113 proceeds to operation 414. At operation 414, the erase suspend component 113 checks if the total number of erase suspends (including fast and slow on-demand erase suspend operations but excluding auto-fixed suspend operations) is below a maximum threshold (e.g., 30). In response to determining that the total number of erase suspends is below a maximum threshold, the erase suspend component 113 proceeds to operation 416 where the erase suspend component 113 selects a slow on-demand erase suspend operation and proceeds to operation 418.

At operation 418, the erase suspend component 113 verifies if the current erase segment is in a list of suspend-eligible segments (e.g., PBE, erase pulse, or verify segments). Based on this verification, the erase suspend component 113 proceeds to operation 420 (e.g., if the current erase segment is in a list of suspend-eligible segments) and the selected erase suspend operation is performed. Otherwise, the erase suspend component 113 proceeds to operation 422, where on-demand suspend operations are prevented, and the erase suspend component 113 relies on auto-fixed suspend points.

This comprehensive decision tree enables intelligent suspend selection while maintaining system stability through controlled suspend operations.

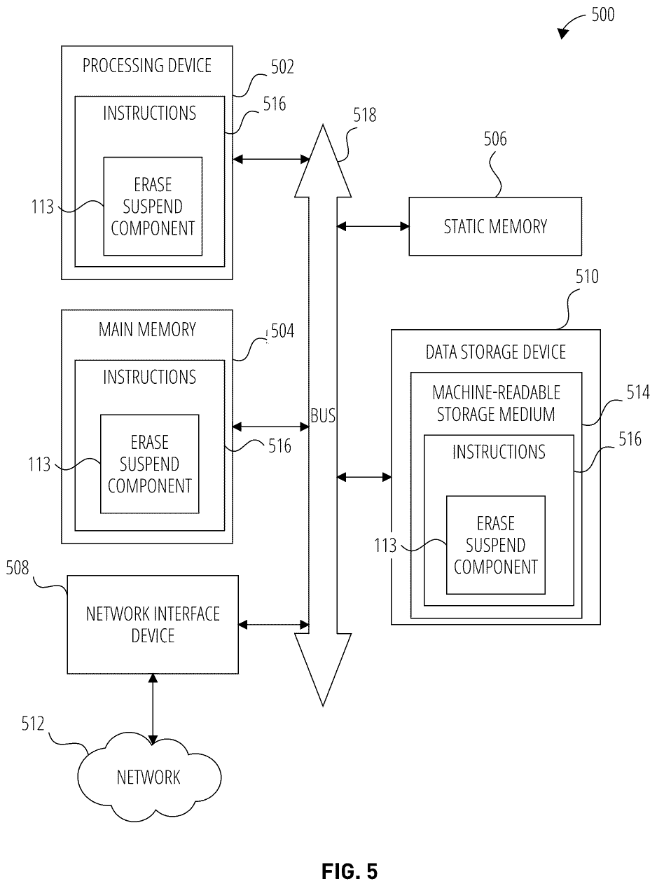

FIG. 5 illustrates an example machine in the form of a computer system 500 within which a set of instructions can be executed for causing the machine to perform any one or more of the methodologies discussed herein. In some examples, the computer system 500 can correspond to a host system (e.g., the host system 120 of FIG. 1) that includes, is coupled to, or utilizes a memory sub-system (e.g., the memory sub-system 110 of FIG. 1) or can be used to perform the operations described herein. In alternative examples, the machine can be connected (e.g., networked) to other machines in a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 500 includes a processing device 502, a main memory 504 (e.g., ROM, flash memory, DRAM such as SDRAM or Rambus DRAM (RDRAM), etc.), a static memory 506 (e.g., flash memory, static random access memory (SRAM), etc.), and a data storage device 510, which communicate with each other via a bus 518.

The processing device 502 represents one or more general-purpose processing devices such as a microprocessor, a central processing unit, or the like. More particularly, the processing device 502 can be a complex instruction set computing (CISC) microprocessor, a reduced instruction set computing (RISC) microprocessor, a very long instruction word (VLIW) microprocessor, a processor implementing other instruction sets, or processors implementing a combination of instruction sets. The processing device 502 can also be one or more special-purpose processing devices such as an application-specific integrated circuit (ASIC), a field programmable gate array (FPGA), a digital signal processor (DSP), a network processor, or the like. The processing device 502 is configured to execute instructions 516 for performing the operations and steps discussed herein. The computer system 500 can further include a network interface device 508 to communicate over a network 512.

The data storage device 510 can include a machine-readable storage medium 514 (also known as a computer-readable medium) on which is stored one or more sets of instructions 516 or software embodying any one or more of the methodologies or functions described herein. The instructions 516 can also reside, completely or at least partially, within the main memory 504 and/or within the processing device 502 during execution thereof by the computer system 500, the main memory 504 and the processing device 502 also constituting machine-readable storage media. The machine-readable storage medium 514, data storage device 510, and/or main memory 504 can correspond to the memory sub-system 110 of FIG. 1.

In one example, the instructions 516 include instructions to implement functionality corresponding to providing block failure protection for a zone memory sub-system as described herein (e.g., the erase suspend component 113 of FIG. 1). While the machine-readable storage medium 514 is shown in an example to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Described implementations of the subject matter can include one or more features, alone or in combination as illustrated below by way of examples.

Example 1. A system comprising: a memory device; and a processing device, operatively coupled to the memory device, programmed to perform operations comprising: determining a QD of pending host read commands while an erase operation is in progress on the memory device; determining whether the QD transgresses a threshold value; in response to determining whether the QD transgresses a threshold value, selecting an erase suspend operation from a plurality of erase suspend operation types; and suspending the erase operation on the memory device using the selected erase suspend operation.

Example 2. The system of Example 1, wherein the plurality of erase suspend operation types comprises at least one of an auto-fixed suspend operation, a fast on-demand suspend operation, or a slow on-demand suspend operation.

Example 3. The system of Example 2, wherein the auto-fixed suspend operation is automatically initiated by the memory device at predetermined suspend points.

Example 4. The system of any one of Examples 2-3, wherein the fast on-demand suspend operation suspends the erase operation at any time point during any segment of a plurality of segments of the erase operation, and wherein suspending the erase operation during an individual segment causes one or more operations of the individual segment to be repeated upon resuming the erase operation.

Example 5. The system of Example 4, wherein the plurality of segments comprises a partial block erase (PBE) segment, an erase pulse segment, and an erase verify segment, wherein the individual segment comprises the erase pulse segment.

Example 6. The system of Example 5, wherein the slow on-demand suspend operation is configured to be performed only during the erase pulse segment and ensures forward progress preventing repetition of the one or more operations upon resuming the erase operation.

Example 7. The system of Example 6, the operations comprising: determining that the QD fails to transgress the threshold value; and in response to determining that the QD fails to transgress the threshold value, selecting the fast on-demand suspend operation as the selected erase suspend operation.

Example 8. The system of Example 7, the operations further comprising: determining a remaining time for completing operations associated with a current segment of the erase operation; and in response to determining that the QD fails to transgress the threshold value and in response to determining that the remaining time fails to transgress a minimum time threshold, selecting the auto-fixed suspend operation as the selected erase suspend operation instead of the fast on-demand suspend operation.

Example 9. The system of Example 8, wherein the minimum time threshold corresponds to an amount of time associated with performing operations for suspending the erase operation.

Example 10. The system of any one of Examples 7-9, wherein the fast on-demand suspend operation is selected in response to determining that a remaining time for completing operations associated with a current segment of the erase operation transgresses a minimum time threshold.

Example 11. The system of any one of Examples 6-10, the operations comprising: determining that the QD transgresses the threshold value; and in response to determining that the QD transgresses the threshold value, selecting the slow on-demand suspend operation as the selected erase suspend operation.

Example 12. The system of any one of Examples 1-12, wherein selecting the erase suspend operation comprises: determining whether a number of suspend operations of a first type of erase suspend operation from the plurality of erase suspend operation types that have been performed is less than a maximum suspend threshold; and preventing selection of the first type of erase suspend operation in response to determining that the number of suspend operations of the first type of erase suspend operation transgresses the maximum suspend threshold.

Example 13. The system of Example 12, wherein the first type of erase suspend operation comprises at least one of a fast on-demand suspend operation or slow on-demand suspend operation.

Example 14. The system of any one of Examples 1-13, wherein selecting the erase suspend operation comprises: accessing erase segment information associated with the erase operation, the erase segment information indicating at least one of a current erase segment of a plurality of erase segments of the erase operation and a time remaining to complete operations associated with the current erase segment; and selecting the erase suspend operation using the erase segment information.

Example 15. The system of Example 14, the operations comprising: preventing selection of an on-demand suspend operation as the selected erase suspend operation in response to determining that the current erase segment comprises a set of operations that are performed in less time than performing the selected erase suspend operation.

Example 16. The operations of Example 15, wherein the current erase segment comprises a select-gate (SG) check segment.

Example 17. The system of any one of Examples 1-16, the operations comprising: tracking a number of fast on-demand suspend operations performed; and separately tracking a total number of on-demand suspend operations performed.

Example 18. The system of any one of Examples 1-17, wherein the memory device comprises a three-dimensional (3D) NAND device.

Example 19. At least one non-transitory machine-readable storage medium comprising instructions that, when executed by a processing device, cause the processing device to perform operations comprising: determining a QD of pending host read commands while an erase operation is in progress on a memory device; determining whether the QD transgresses a threshold value; in response to determining whether the QD transgresses a threshold value, selecting an erase suspend operation from a plurality of erase suspend operation types; and suspending the erase operation on the memory device using the selected erase suspend operation.

Example 20. A method comprising: determining a QD of pending host read commands while an erase operation is in progress on a memory device; determining whether the QD transgresses a threshold value; in response to determining whether the QD transgresses a threshold value, selecting an erase suspend operation from a plurality of erase suspend operation types; and suspending the erase operation on the memory device using the selected erase suspend operation.

The term “coupled with” generally refers to a connection between components, which can be an indirect communicative connection or direct communicative connection (e.g., without intervening components), whether wired or wireless, including connections such as electrical, optical, magnetic, and the like.

“System data” refers to data that is created and/or maintained by the memory sub-system for performing operations in response to host requests and for media management.

“User data” generally refers to host data and garbage collection data.

“Transgress” refers to exceeding or going above a threshold value.

“Queue depth” refers to the number of outstanding read or write commands that are pending from the host system to the memory sub-system at any given time.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, ROMs, RAMs, EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium (such as a non-transitory machine-readable medium) having stored thereon instructions, which can be used to program a computer system (or other electronic devices) to perform a process according to the present disclosure. A machine-readable medium includes any mechanism for storing information in a form readable by a machine (e.g., a computer). In some examples, a machine-readable (e.g., computer-readable) medium includes a machine (e.g., a computer) readable storage medium such as a ROM, RAM, magnetic disk storage media, optical storage media, flash memory components, and so forth. A machine-readable storage medium can be non-transitory (in other words, not having any transitory signals) in that it does not embody a propagating signal. However, labeling a machine-readable storage medium “non-transitory” should not be construed to mean that the machine-readable storage medium is incapable of movement; the machine-readable storage medium should be considered as being transportable from one physical location to another.

In the foregoing specification, examples of the disclosure have been described with reference to specific examples thereof. It will be evident that various modifications can be made thereto without departing from the broader scope of examples of the disclosure as set forth in the following claims. The specification and drawings are, accordingly, to be regarded in an illustrative sense rather than a restrictive sense.

What is claimed is:

1. A system comprising:
a memory device; and
a processing device, operatively coupled to the memory device, programmed to perform operations comprising:
determining a queue depth of pending host read commands while an erase operation is in progress on the memory device;
determining whether the queue depth transgresses a threshold value;
in response to determining whether the queue depth transgresses the threshold value, selecting an erase suspend operation from a plurality of erase suspend operation types; and
suspending the erase operation on the memory device using the selected erase suspend operation.

2. The system of claim 1, wherein the plurality of erase suspend operation types comprises at least one of an auto-fixed suspend operation, a fast on-demand suspend operation, or a slow on-demand suspend operation.

3. The system of claim 2, wherein the auto-fixed suspend operation is automatically initiated by the memory device at predetermined suspend points.

4. The system of claim 2, wherein the fast on-demand suspend operation suspends the erase operation at any time point during any segment of a plurality of segments of the erase operation, and wherein suspending the erase operation during an individual segment causes one or more operations of the individual segment to be repeated upon resuming the erase operation.

5. The system of claim 4, wherein the plurality of segments comprises a partial block erase (PBE) segment, an erase pulse segment, and an erase verify segment, wherein the individual segment comprises the erase pulse segment.

6. The system of claim 5, wherein the slow on-demand suspend operation is configured to be performed only during the erase pulse segment and ensures forward progress preventing repetition of the one or more operations upon resuming the erase operation.

7. The system of claim 6, the operations comprising:
determining that the queue depth fails to transgress the threshold value; and
in response to determining that the queue depth fails to transgress the threshold value, selecting the fast on-demand suspend operation as the selected erase suspend operation.

8. The system of claim 7, the operations further comprising:
determining a remaining time for completing operations associated with a current segment of the erase operation; and
in response to determining that the queue depth fails to transgress the threshold value and in response to determining that the remaining time fails to transgress a minimum time threshold, selecting the auto-fixed suspend operation as the selected erase suspend operation instead of the fast on-demand suspend operation.

9. The system of claim 8, wherein the minimum time threshold corresponds to an amount of time associated with performing operations for suspending the erase operation.

10. The system of claim 7, wherein the fast on-demand suspend operation is selected in response to determining that a remaining time for completing operations associated with a current segment of the erase operation transgresses a minimum time threshold.

11. The system of claim 6, the operations comprising:
determining that the queue depth transgresses the threshold value; and
in response to determining that the queue depth transgresses the threshold value, selecting the slow on-demand suspend operation as the selected erase suspend operation.

12. The system of claim 1, wherein selecting the erase suspend operation comprises:
determining whether a number of suspend operations of a first type of erase suspend operation from the plurality of erase suspend operation types that have been performed is less than a maximum suspend threshold; and
preventing selection of the first type of erase suspend operation in response to determining that the number of suspend operations of the first type of erase suspend operation transgresses the maximum suspend threshold.

13. The system of claim 12, wherein the first type of erase suspend operation comprises at least one of a fast on-demand suspend operation or slow on-demand suspend operation.

14. The system of claim 1, wherein selecting the erase suspend operation comprises:
accessing erase segment information associated with the erase operation, the erase segment information indicating at least one of a current erase segment of a plurality of erase segments of the erase operation and a time remaining to complete operations associated with the current erase segment; and
selecting the erase suspend operation using the erase segment information.

15. The system of claim 14, the operations comprising:
preventing selection of an on-demand suspend operation as the selected erase suspend operation in response to determining that the current erase segment comprises a set of operations that are performed in less time than performing the selected erase suspend operation.

16. The operations of claim 15, wherein the current erase segment comprises a select-gate (SG) check segment.

17. The system of claim 1, the operations comprising:
tracking a number of fast on-demand suspend operations performed; and
separately tracking a total number of on-demand suspend operations performed.

18. The system of claim 1, wherein the memory device comprises a three-dimensional (3D) NAND device.

19. At least one non-transitory machine-readable storage medium comprising instructions that, when executed by a processing device, cause the processing device to perform operations comprising:
determining a queue depth of pending host read commands while an erase operation is in progress on a memory device;
determining whether the queue depth transgresses a threshold value;
in response to determining whether the queue depth transgresses the threshold value, selecting an erase suspend operation from a plurality of erase suspend operation types; and
suspending the erase operation on the memory device using the selected erase suspend operation.

20. A method comprising:
determining a queue depth of pending host read commands while an erase operation is in progress on a memory device;
determining whether the queue depth transgresses a threshold value;
in response to determining whether the queue depth transgresses the threshold value, selecting an erase suspend operation from a plurality of erase suspend operation types; and
suspending the erase operation on the memory device using the selected erase suspend operation.
